(19) United States
(12) Patent Application Publication
(10) Pub. No.: US 2020/0406948 A1
(43) Pub. Date: Dec. 31, 2020

(54) Arrangement in an Electric Vehicle and a Pallet Jack

(71) Applicant: Maslog Oy, Seinäjoki (FI)

(72) Inventor: Teemu SAUKKIO, Turku (FI)

(73) Assignee: Maslog Oy, Seinäjoki (FI)

(21) Appl. No.: 16/979,193

(22) PCT Filed: Mar. 11, 2019
(86) PCT No.: PCT/FI2019/050202

§ 371 Date: Sep. 9, 2020

(30) Foreign Application Priority Data
Mar. 9, 2018 (FI) 20185218

(51) Int. Cl. B62B 5/00; B62B 5/06; H02K 7/00; H02K 7/08; H02K 11/20; H02K 11/30

(52) U.S. Cl. CPC B62B 5/004; B62B 5/06; B62B 5/0073; H02K 11/30; H02K 7/083; H02K 11/20; H02K 7/006

(57) ABSTRACT

The invention relates to an arrangement in an electric vehicle, to at least one wheel of which vehicle an electric motor has been fitted. The electric motor comprises a rotor fitted to be on the outer side and a stator fitted to be on the inner side. The stator of the electric motor is arranged to function as a wheel axis, so that the stator is fitted to bear the loads between said wheel and the remaining structure of the vehicle. Additionally, the arrangement is equipped with an assistance unit, which comprises a motor control unit and a sensor arrangement, which the sensor arrangement is arranged to identify a force directed by an operator to the vehicle, which the vehicle is moveable by the force of the operator, and to produce a sensor signal from it, and which the control unit is arranged to control the operation of the motor based on the sensor signal.

### BACKGROUND

An object of the invention is an arrangement in an electric vehicle, to at least one wheel of which vehicle an electric motor has been fitted, which electric motor comprises a rotor fitted to be on the outer side and a stator fitted to be on the inner side.

A further object of the invention is a pallet jack.

Electric motor structures are known, which are fitted on a wheel so that the rotating rotor of the motor is on the outer periphery and connected directly to rotate the wheel without power transmission in between.

The problem with known solutions is their complexity.

### BRIEF DESCRIPTION

The arrangement according to the invention is characterized by what is presented in the characterizing part of the independent claim. Other embodiments of the invention are characterized by what is presented in the other claims.

Inventive embodiments are also shown in the description and drawings of this application. The inventive content of the application can also be defined in other ways than what is done in the claims below. The inventive content can also be formed from several separate inventions, especially if the invention is viewed in the light of expressed or implicit partial tasks or in terms of achieved benefits or benefit groups. Thus, some of the definitions included in the claims below can be unnecessary in terms of separate inventive ideas. The features of different embodiments of the invention can within the basic inventive idea be applied in connection with other embodiments.

The idea of the invention is that the stator of the electric motor functions as a wheel axis, whereby the stator bears the loads between said wheel and the remaining structure of the vehicle.

An advantage is that the structure of the motor and thus the vehicle can be made simple.

The idea of one embodiment is that the vehicle is equipped with an assistance unit, which has the motor's control unit and a sensor arrangement, which the sensor arrangement is arranged to identify a force applied by the operator to the vehicle and to produce a sensor signal from it, based on which signal the control unit controls the operation of the motor.

An advantage is that the handling of the vehicle is made lighter.

### BRIEF DESCRIPTION OF THE DRAWINGS

Some embodiments of the invention are described in further detail in the enclosed drawings, in which

FIG. 1 illustrates a schematic cross section of one arrangement according to the invention,

FIG. 2 illustrates in a schematic way the arrangement according to FIG. 1 seen from the side, and

FIG. 3 illustrates in a schematic way a vehicle.

For the sake of clarity, some embodiments of the invention are shown in the figures in a simplified manner. Similar parts are marked in the figures with the same reference numbers.

### DETAILED DESCRIPTION

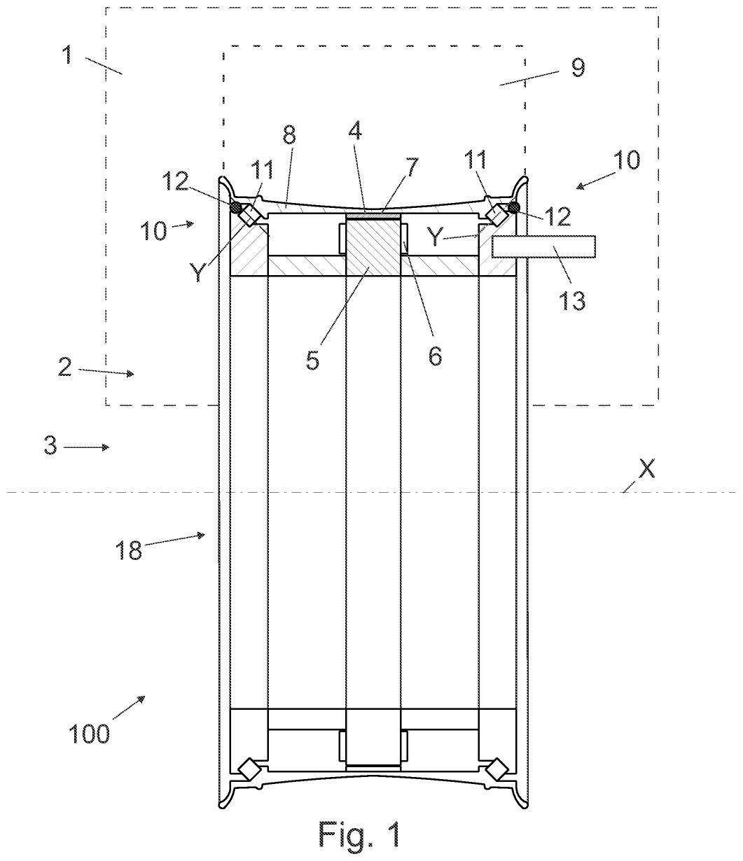

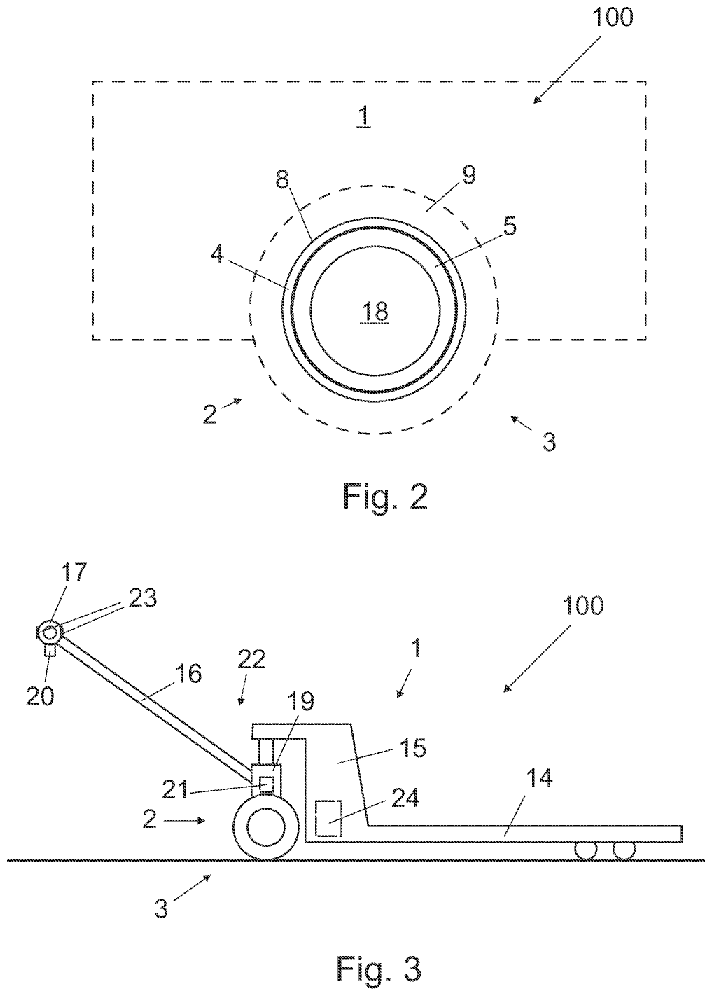

FIG. 1 shows a schematic cross section of one arrangement according to the invention, and FIG. 2 shows it from the side.

The arrangement 100 is fitted in the electric vehicle 1, which is shown in the figures with dotted lines and in a simplified manner. The vehicle 1 comprises at least one wheel 2, to which the electric motor 3 is fitted. Said electric motor 3 comprises a rotor 4 fitted to be on the outer side and a ring-like stator 5 fitted to be on the inner side. The electric motor 3 can to its type be a brushed or brushless, alternating current or direct current motor.

The stator 5 of the electric motor is arranged to function as a wheel 2 axis, so that the stator 5 is fitted to bear the loads between said wheel 2 and the remaining structure of the vehicle 1. A separate wheel hub is thus not needed in the arrangement 100. The stator 5 is attached with attaching means 13 to the remaining structure of the vehicle. The attaching means 13 is an attaching means known as such, which makes possible the detaching and reattaching of the stator and the entire electric motor, such as for example a bolt. On the other hand, the attaching means 13 can be a welding joint or gluing, which must be broken in order to detach the stator 5 and electric motor.

The stator 5 can be attached to the remaining structure of the vehicle on its one side, as is shown in FIG. 1, on both sides, or from the direction of the empty space 18 formed by the inner perimeter of the ring-like stator 5, or with different combinations of these. The stator 5 can further be attached over the length of its entire side or inner perimeter, or alternatively only on part of the length of the side or inner perimeter. In other words, attaching means 13 can be placed around the stator 5 or only on a certain part or sector of it.

In one embodiment the stator 5 is attached to the vehicle body or subframe. In another embodiment, the stator 5 is attached to the wheel support of the vehicle, which can be mounted on springs and/or shock absorbers in relation to the remaining body of the vehicle.

In the embodiment shown in FIG. 1, the stator 5 comprises a winding 6 formed with winding wires, while the rotor 4 comprises magnets 7, advantageously permanent magnets.

In the embodiment shown in FIG. 1, the widths of the stator winding 6 and the rotor magnet 7 in the direction of the rotational axis X of the wheel are substantially smaller than the width of the wheel.

In the embodiment shown in FIG. 1, the wheel 2 comprises a rim base 8 and thereon fitted a tire 9 (shown with dotted lines), and the rotor 4 is attached directly on the rim base 8. Attaching methods and means known as such can be used for attaching the rotor to the rim base.

In another embodiment, there are one or more structural layers between the rotor 4 and the rim base 8. Such a structural layer can be functional, it can for example dampen vibrations between the rotor and the rim base, or function as an element assisting in the attaching of the rotor and rim base.

It should be remarked that the tire can be a tire known as such: air-filled, solid tire, foam-filled etc. It should further be remarked that a separate tire 9 is not at all necessary, but the rim base 8 can form the wear surface, on which the wheel 2 rotates on the driving surface.

In the embodiment shown in FIG. 1, the rotor 4 is mounted to the stator 5 by roller bearings 10, the rotational axes Y of the bearing rollers 11 of which are fitted in a separate direction relative to the rotational axis X of the wheel. An advantage is that the bearings are supported both in the direction of the rotational axis X of the wheel and in a perpendicular direction to this direction. The now mentioned angle is 45°, but it can of course also be something else. It must further be remarked that the bearings between the rotor 4 and the stator 5 can also be implemented in another way than with roller bearings. The bearings are dimensioned so that the stator 5 functions as the wheel 2 axis, which bears all the load transmitted from the vehicle via the wheel to the driving surface. In other words, the bearings between the rotor 4 and the stator 5 functions as the single wheel bearing of the wheel 2.

In the embodiment shown in FIG. 1, sealings 12 are fitted between the rotor 4 and the stator 5, so that a sealed space is formed for the electromagnetic parts of the rotor and stator.

FIG. 3 shows in a schematic way a vehicle. According to one idea, the vehicle 2 can be a manually used vehicle moved with the operator's muscular strength. The vehicle 2 shown in FIG. 3 is a forklift, i.e. a pallet jack, which is used for example in warehouses and distribution centres for moving pallets and different goods, and which moves as pulled or pushed by an operator.

A typical pallet jack comprises two parallel lifting shafts 14, which are attached to the frame 15 of the pallet jack. Additionally, the pallet jack has a shaft 16, the first end of which has a handle part 17, from which the operator moves and steers the pallet jack, and uses the height adjustment arrangement which lifts and lowers the pallet jack. The second end of the shaft 16 is attached to a subframe 19, which can be turned with the aid of the shaft 16 in relation to the frame 15. A wheel 2 or a wheel pair comprising an electric motor 3 is attached to the subframe 19. There are smaller wheels or rollers in the second end of the lifting shafts 14.

The vehicle has naturally been fitted with a power source 21, such as a battery 24, for using the electric motor 3. The battery 24 can for example be a lithium or lead battery.

Management means 20 for the motor have been arranged in the handle part 17, via which the control unit 21 of the motor and further the operation of the electric motor 3 is controlled.

In one embodiment the arrangement 100 is equipped with an assistance unit 22, which comprises a sensor arrangement 23 and which is connected to the control unit 21 of the motor. The sensor arrangement 23 is arranged to identify a force applied by the operator to the vehicle 1 and to produce a sensor signal from it to the control unit 21. In the embodiment shown in FIG. 3, the sensor arrangement 23 is fitted in the handle part 17. The force to be identified can be a force caused by the operator's palm to the handle part and/or a pressure caused by the operator to the handle part.

From the motor management means 20, an assisting mode of operation can be selected, whereby the assistance unit 22 is switched on. According to one idea, the electric motor 3 gives power and rotates the wheel 2 more the bigger the force used by the operator is that the sensor arrangement 23 detects.

According to another idea, the sensor arrangement 23 of the assistance unit 22 is fitted in the shaft 16 or between the shaft 16 and the subframe 19, so that the force active in the shaft 16 is identified, and the operation of the electric motor 3 is controlled based on this force.

According to yet another idea, the sensor arrangement 23 of the assistance unit 22 is fitted to identify the weight of the load fitted onto the pallet jack, and based on this the operation of the electric motor 3 is controlled, i.e. the electric motor 3 gives more assistance the greater the weight is.

In one embodiment the sensor arrangement 23 is arranged to identify a change in the speed of the vehicle, which can be detected for example from a change in the speed of the wheel 2. The assistance unit 22 can increase the assistance given by the electric motor 3, if the speed of the vehicle decreases in a predetermined manner; and in the opposite situation when the speed of the vehicle increases in a predetermined manner, decrease the assistance given by the electric motor 3.

According to one idea, the assistance given by the electric motor 3 is controlled so that the force, which the operator must use to move the vehicle, at least substantially remains constant.

According to one idea, the control of the assistance function can be implemented with a computer program code run in a processor comprised in the assistance unit 22, which code can be downloaded from the device's internal memory. The computer program code can be transferred into the device from a separate external memory device, or via some telecommunications network, for example by connecting the device to the Internet via a wireless access network.

It should be remarked in this context that the above-described assistance unit 22 can also be used in connection with other arrangements than the above-described arrangement equipped with an electric motor. Thus, the electrically assisted pallet jack can be equipped with a conventional electric motor, where the rotor is on the inner side and the stator is on the outer side, and the above-described assistance unit 22 can be connected thereto. The electric motor can be fitted to the vehicle in the most practical manner and switched to rotate the wheel with a power transmission known as such. Alternatively, the electric motor can have the rotor on the outer side and the stator on the inner side of this, but where, as opposed to what is presented above, there is a separate wheel hub.

In any case, the structure and operation of the assistance function of the pallet jack can be as described above.

In some cases, the features presented in this application can be used as such, regardless of other features. On the other hand, features presented in this application can, if necessary, be combined to form different combinations.

As a summary it can be noted that the arrangement according to the invention is characterized in that the stator of the electric motor is arranged to function as the wheel axis, so that the stator is fitted to bear the loads between said wheel and the remaining structure of the vehicle.

It can further be noted that the pallet jack according to the invention is characterized in that the pallet jack is equipped with an assistance unit, which comprises the motor's control unit and a sensor arrangement, which sensor arrangement is arranged to identify a force applied by the operator to the vehicle and to produce a sensor signal from it, and which control unit is arranged to control the operation of the motor based on the sensor signal.

The drawings and descriptions related thereto are only meant to illustrate the idea of the invention. For someone skilled in the art it is clear that the invention is not limited to the above described embodiments, where the invention is described with the aid of certain examples, but many variations and different applications of the invention are possible within the inventive idea defined by the claims presented below.

### REFERENCE NUMBERS

1 vehicle
2 wheel
3 electric motor
4 rotor
5 stator
6 winding
7 magnet
8 rim base
9 tire
10 roller bearings
11 bearing roller
12 sealing
13 attaching means
14 lifting shaft
15 body
16 shaft
17 handle part
18 empty space
19 subframe
20 motor management means
21 motor control unit
22 assistance unit
23 sensor arrangement
24 battery
100 arrangement
X wheel rotational axis
Y bearing roller rotational axis

1. An arrangement in an electric vehicle, to at least one wheel of the vehicle an electric motor has been fitted, which the electric motor comprises
a rotor fitted to be on outer side,
a stator fitted to be on inner side,
the stator of the electric motor is arranged to function as an axis of said wheel, so that the stator is fitted to bear loads between said wheel and remaining structure of the vehicle, wherein the arrangement is equipped with an assistance unit, which comprises a motor control unit and a sensor arrangement, which the sensor arrangement is arranged to identify a force applied by an operator to the vehicle, which the vehicle is moveable by the force of the operator, and to pro-duce a sensor signal from it, and which the control unit is arranged to control operation of the motor based on the sensor signal.

2. The arrangement according to claim 1, wherein the wheel comprises a rim base and thereon fitted a tire, and that the rotor is fitted directly onto the rim base.

3. The arrangement according to claim 1, wherein the rotor is mounted to the stator by roller bearings, wherein rotational axes of rollers of the roller bearings are fitted in a separate direction relative to a rotational axis of the wheel.

4. The arrangement according to claim 3, wherein the rotational axes of the rollers of the roller bearings are fitted at a 45° angle in relation to the rotational axis of the wheel.

5. The arrangement according to claim 1, wherein sealings are fitted between the rotor and the stator, so that a sealed space is formed for the electromagnetic parts of the rotor and stator.

6. The arrangement according to claim 1, wherein the stator comprises a winding, and the rotor a magnet.

7. The arrangement according to claim 6, wherein widths of the stator winding and the rotor magnet in a direction of the rotational axis of the wheel are substantially smaller than a width of the wheel.

8. The arrangement according to claim 1, wherein the sensor arrangement is fitted in a handle part meant for moving the vehicle, so that the force to be identified is the force caused by a palm of the operator palm to the handle part.

9. A pallet jack, which the pallet jack is moveable by a force applied by an operator, wherein it comprises
an electric motor fitted to at least one wheel of the pallet jack, wherein the electric motor comprises
a rotor fitted to be on outer side,
a stator fitted to be on inner side,
the stator of the electric motor is arranged to function as an axis of said wheel, so that the stator is fitted to bear loads between said wheel and remaining structure of the pallet jack, and the pallet jack
is equipped with an assistance unit, which comprises a motor control unit and a sensor arrangement which the sensor arrangement is arranged to identify the force applied by the operator to the pallet jack and to produce a sensor signal from it, and which the control unit is arranged to control the operation of the motor based on the sensor signal.

10. (canceled)

11. (canceled)

12. (canceled)
